(19) United States
(12) Patent Application Publication
(10) Pub. No.: US 2017/0273850 A1
(43) Pub. Date: Sep. 28, 2017

(54) TRIGGER POINT THERAPY DEVICE

(71) Applicant: NEW PELVIC PAIN TECHNOLOGIES INC., San Francisco, CA (US)

(72) Inventor: DAVID WISE, SAN FRANCISCO, CA (US)

(73) Assignee: NEW PELVIC PAIN TECHNOLOGIES INC., San Francisco, CA (US)

(21) Appl. No.: 15/464,923

(22) Filed: Mar. 21, 2017

Related U.S. Application Data
(60) Provisional application No. 62/312,655, filed on Mar. 24, 2016.

(51) Int. Cl. A61H 1/00

(52) U.S. Cl. CPC A61H 1/008

(57) ABSTRACT

A trigger point therapy device for applying pressure to a localized area of myofascial tissue that is accessed from the exterior of a patient's body. The therapy device includes a base portion has top and bottom surfaces that define a width dimension for the base portion. The therapy device also includes a pressure applicator that is connected to the base portion. The device allows an equivalent amount of pressure to be applied while the patient is lying on a soft surface as compared to lying on a hard surface. This increases the length of time that a patient will can comfortably use the device and promotes usage of the device by the patient. A method includes placing the device on a soft surface and positioning a patient on the soft surface to place the pressure applicator in engagement with the localized area of myofascial tissue.

### CROSS-REFERENCE TO RELATED APPLICATIONS

This application claims the benefit of U.S. Provisional Application Ser. No. 62/312,655, filed on Mar. 24, 2016.

### TECHNICAL FIELD

The disclosure relates to methods and apparatuses for releasing trigger points.

### BACKGROUND

Some types of chronic pain are associated with myofascial trigger points. Trigger points are taut bands within muscles either at the surface of the muscle, inside the muscle, in the belly or the attachment of the muscle. These trigger points are like mini-spasms in muscle, and may refer pain to remote sites. In some cases, pressing a trigger point causes recreation of a patient's symptoms. When pressed in a specific way for a certain duration these trigger points can release, often attended by a significant reduction or abatement in pain and dysfunction.

Self-release techniques are commonly performed by physical therapists, chiropractors, and other professionals, or by patients themselves that suffer from pain from trigger points. In its simplest and most effective form, trigger point release may be performed by pressing on the trigger point with a finger or fingers for a period of time. Other methods use devices to assist in trigger point release. Sometimes, patients are instructed to use a ball pressed against a wall to assist in trigger point release. Sometimes, the patient may lay on a surface, such as a floor, and place the ball under the trigger point in order to release it.

### SUMMARY

One aspect of the disclosure is a trigger point therapy device for applying pressure to a localized area of myofascial tissue that is accessed from an exterior of a patient's body. The therapy device includes a base portion that has a top surface and a bottom surface that are oriented transverse to an axis and extend outward from the axis to define a width dimension for the base portion. The therapy device also includes a pressure applicator that is rigidly connected to the base portion and extends upward from the top surface along the axis.

The width dimension of the base portion may be at least twice a width dimension of the pressure applicator. A height dimension of the pressure applicator may be equal to or greater than the width dimension of the pressure applicator. At least part of the pressure applicator may be hemispherical. At least part of the pressure application may be spherical. At least part of the pressure applicator may be formed from a flexible material. The base portion may be formed from a rigid material and have a circular periphery. The pressure applicator may be positioned in a radial center of the circular periphery of the base portion. The base portion may be designed so that it will not damage a soft surface on which it is placed. At least one of the top surface of the base portion or the bottom surface of the base portion may be planar. The pressure applicator can be removeably attached to the base portion.

The trigger point therapy device can also include a connecting structure that extends upward from the top surface of the base portion along the axis and connects the pressure applicator to the base portion. The pressure applicator may be removably attached to the connecting structure. The trigger point therapy device may include a second pressure applicator that is connected to the base portion and extends upward from the top surface of the base portion along a second axis that is parallel to the axis.

The trigger point therapy device may include a first set of connecting structures and a second set of connecting structures. The first set of connecting structures are removably connectable to the pressure applicator and the base portion, and the second set of connecting structures are removably connectable to the second pressure applicator and the base portion. One of the connecting structures from the first set of connecting structures may be connected to the pressure applicator and the base portion at a time and can be replaced by another connecting structure from the first set of connecting structures at a user's discretion. One of the connecting structures from the second set of connecting structures may be connected to the second pressure applicator and the base portion at a time and can be replaced by another connecting structure from the second set of connecting structures at the user's discretion. The lengths of the connecting structures from the first set of connecting structures can vary, and the lengths of the second set of connecting structures can vary. The pressure applicator may have a first diameter that is different than a second diameter of the second pressure applicator.

The trigger point therapy device may include a first connecting structure and a second connecting structure. The first connecting structure extends upward from the top surface of the base portion along the axis and connects the pressure applicator to the base portion. The second connecting structure extends upward from the top surface of the base portion along the second axis and connects the second pressure applicator to the base portion. A length of the first connecting structure is longer than a length of the second connecting structure.

The trigger point therapy device may also include a supporting member having a ring-like configuration. The supporting member is connected to the base portion and surrounds the pressure applicator. A connecting structure may extend upwards from the top surface of the base portion along the axis and connect the pressure applicator to the base portion. The supporting member may surround the connecting structure and the pressure applicator, with at least a portion of the pressure applicator extending beyond the supporting member. The thickness of the supporting member may decrease from an inner periphery to an outer periphery.

Another aspect of the disclosure is method for applying pressure to a localized area of myofascial tissue from an exterior of a patient's body. The method includes placing a device on a soft surface. The device includes a base portion that has a top surface and a bottom surface that are oriented transverse to an axis and extend outward from the axis to define a width dimension for the base portion. The device also includes a pressure applicator that is connected to the base portion and extends upward from the top surface along the axis. The device is placed on the soft surface such that the bottom surface of the device is supported by the soft surface and the pressure applicator extends upward relative to the soft surface. The method also includes positioning a patient on the soft surface such that the device is located between the patient and the soft surface and the pressure applicator is in engagement with the trigger point or localized area of myofascial restriction.

### BRIEF DESCRIPTION OF THE DRAWINGS

FIG. 1 is a perspective view showing a trigger point therapy device according to a first example.

FIG. 2 is a top view of the trigger point therapy device of FIG. 1.

FIG. 3 is a side view of the trigger point therapy device of FIG. 1.

FIG. 4 is a side cross-section view of the trigger point therapy device of FIG. 1.

FIG. 5 is an illustration showing use of the trigger point therapy device of FIG. 1.

FIG. 6 is a side view showing a trigger point therapy device according to a second example.

FIG. 7 is a side view showing a trigger point therapy device according to a third example.

FIG. 8 is a side view showing a trigger point therapy device according to a fourth example.

FIG. 9 is a perspective view showing a trigger point therapy device according to a fifth example.

FIG. 10 is a perspective view showing a trigger point therapy device according to a sixth example.

FIG. 11 is a cross-section view of the trigger point therapy device of FIG. 10.

FIG. 12 is an exploded perspective view showing a trigger point therapy device according to a seventh example.

FIG. 13 is a side view of the trigger point therapy device of FIG. 12.

FIG. 14 is an exploded perspective view showing a trigger point therapy device according to an eighth example.

FIG. 15 is a bottom view of the trigger point therapy device of FIG. 14.

### DETAILED DESCRIPTION

Like any therapy technique, self-administered trigger point release is effective only to the extent that patients utilize the technique. Medical professionals refer to this as compliance, which describes the extent to which a patient follows medical advice. Compliance is a complex subject, and reasons why patients are non-compliant are varied.

For trigger point release techniques that apply pressure using a ball or similar object, patients are often directed to perform the techniques while pressing against a wall or lying on a hard surface. Because pressing against a wall or lying on a hard surface is uncomfortable, the willingness of the patient to use the technique is diminished, which often manifests as short sessions of using the technique or non-use of the technique. Performing trigger point release using a ball or similar object while lying on a soft surface is less effective or not effective, because the ball causes a significant localized deformation in the soft surface, which decreases the amount of upward pressure applied to the patient's body by the ball as compared to use of the ball while lying on a hard surface.

The devices described herein are intended to significantly increase the patient's compliance and usage of trigger point release techniques by making those techniques more comfortable, more convenient, and more efficacious. In particular, the devices and methods described herein permit effortless trigger point release while lying on a soft surface by attaching a pressure applicator to a stable base that limits the degree of deformation of the underlying soft surface by spreading the resulting load over a larger area. Examples of soft surfaces include a cushion, a couch or sofa, or a bed mattress. The patent may also be able to engage in other activities while comfortably performing trigger point release, such as watching television or listening to music.

As discussed herein, comfort and convenience of self-administered trigger point release are qualitatively enhanced while maintaining efficacy using therapy device that includes a base portion that has a top surface and a bottom surface that are oriented transverse to an axis and extend outward from the axis to define a width dimension for the base portion, and a pressure applicator that is connected to the base portion and extends upward from the top surface along the axis. The trigger point therapy device is used to apply pressure to a localized area of myofascial tissue that is accessed from the exterior of a patient's body. The device allows trigger point release to be performed while the patient is resting comfortably on a soft surface, by supporting the pressure applicator relative to the soft surface using the base portion. The upward pressure applied by the pressure applicator is not significantly diminished by placing the device on the soft surface. Methods for applying pressure to a localized area of myofascial tissue from the exterior of a patient's body using the device while the patient lies on a soft surface are also described herein.

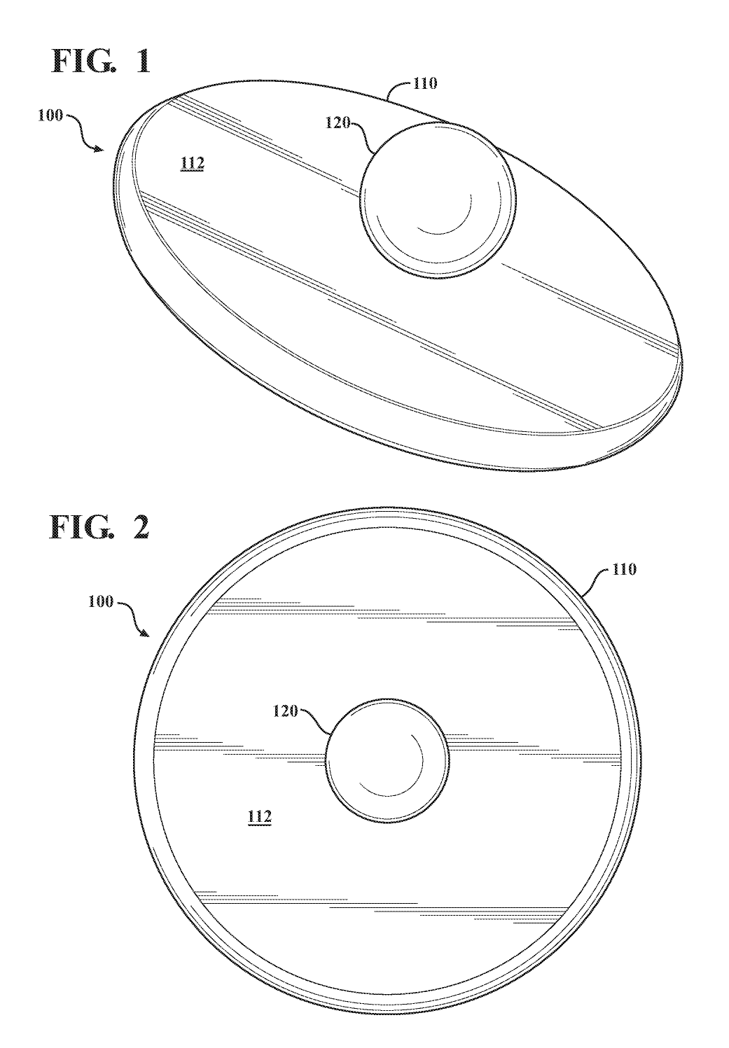

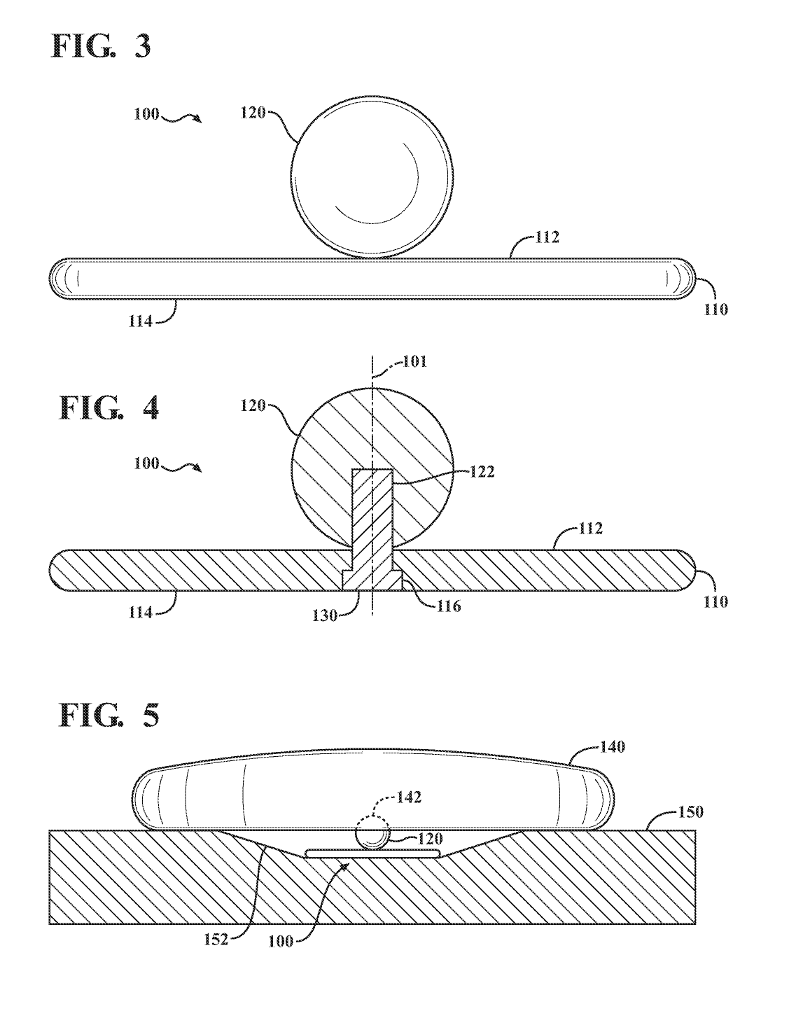

FIGS. 1-3 show a therapy device 100 according to a first embodiment. As will be explained herein, the therapy device 100 is configured to apply pressure to a discrete treatment site, such as a myofascial trigger point within the muscles of a patient. The therapy device 100 is intended for external use, by pressing against the skin of the patient, whether through clothing or applied directly to the patient's skin. As examples, the therapy device 100 may be used to release trigger points located in the patient's muscles in the areas of the lower back, pelvis, and legs. The therapy device 100 is not limited to use in these areas, however, and may be used to release myofascial trigger points on other locations of the patient's body.

The therapy device 100 includes a base portion 110 and a pressure applicator 120. The base portion 110 supports the pressure applicator 120 in a manner that allows the therapy device to be used while it is on a soft surface, as will be discussed further herein.

The base portion 110 is wide relative to the pressure applicator 120 in order to provide a stable support for the pressure applicator 120. Because a patient's body is at least partly supported by the pressure applicator 120 during use of the therapy device 100, the larger width of the base portion 110 as compared to the pressure applicator 120 allows the force applied at the pressure applicator 120 to be spread over a larger underlying surface. This allows the therapy device 100 to be used while the therapy device 100 is positioned on a soft surface, without causing large local deformations within the soft surface. Although not limited to any specific material, the base portion 110 may be formed from a rigid material.

The base portion 110 may be a planar element that has a top surface 112 and a bottom surface 114. The top surface 112 and the bottom surface 114 may each be flat. The top surface 112 and the bottom surface 114 may each define planes that are parallel to each other. In implementations where the top surface 112 and the bottom surface 114 are planar, the top surface 112 and the bottom surface 114 may be spaced by a consistent distance. The distance between the top surface 112 and the bottom surface 114 defines a depth dimension of the base portion 110. In alternative implementations, one or both of the top surface 112 and the bottom surface 114 may be curved. Although the base portion 110 is rigid, a padding material by be applied to the exterior of the base portion 110, such as on the top surface 112.

In the illustrated example, the base portion 110 has a curved periphery. The curved shape of the periphery of the base portion 110 allows the base portion 110 to cause an even deformation in an underlying soft surface over a large area. In the illustrated example, the base portion 110 has a circular periphery and the pressure applicator 120 is positioned at a radial center of the circular periphery. The therapy device 100 is not, however, limited to a particular shape for the base portion 110, and other shapes can be used.

The depth dimension of the base portion 110 may be small as compared to a width dimension of the base portion 110. In the illustrated example, the base portion 110 has a depth dimension of approximately 0.75 inches (1.9 cm) and a width dimension of approximately 10 inches (25.4 cm). As examples, the depth dimension of the base portion 110 may range between 0.25 inches (6.35 mm) and 1.5 inches (3.81 cm) and the width dimension of the base portion 110 may range between 3 inches (7.62 cm) and 20 inches (50.8 cm).

The pressure applicator 120 is used to apply pressure to a treatment area on a patient's body, such as a localized area of myofascial tissue. The pressure applicator 120 may contact the patient's skin directly or through clothing. The pressure applicator 120 may have a curved profile in the area that contacts the treatment area. The curved profile may define, as examples, a portion of a sphere or a portion of a cylinder. Other curved profiles may be used. In some implementations, at least part of the pressure applicator 120 defines a hemispherical shape. In some implementations at least part of the pressure applicator 120 defines a spherical shape.

The pressure applicator 120 may be formed from a flexible material that is able to deform somewhat upon contact with the treatment site, and resiliently return to its former shape when engagement with the treatment site is released. The pressure applicator 120 may be formed from soft rubber. In one implementation the pressure applicator 120 has a Shore C hardness of approximately 50-55. Acceptable results can also be achieved in implementations where the pressure applicator 120 has a Shore C hardness of approximately 25-70. For example, the pressure applicator 120 may be a spherical ball-like member similar to a lacrosse ball. The range of acceptable hardness values is not, however, limited to the particular ranges set forth herein.

The width of the pressure applicator 120 may be small compared to the width of the base portion 110. For example, the width of the base portion 110 may be at least twice the width of the pressure applicator 120. In the illustrated implementation, the pressure applicator 120 has a width of approximately 2.5 inches (6.35 cm). In other implementations, the width of the pressure applicator 120 may range from one half inch (1.27 cm) to 4 inches (10.16 cm).

As seen in FIG. 4, the pressure applicator 120 may be fastened to the base portion 110 by a connecting structure 130. In the illustrated example, the connecting structure 130 is seated in an aperture 116 formed through the base portion 110 and in a bore 122 that is formed part way into the pressure applicator 120. The aperture 116, the bore 122, and the connecting structure 130 may extend along an axis 101 of the therapy device 100.

In the illustrated example, the connecting structure 130 is separate from the base portion 110 and the pressure applicator 120 and is connected to both the base portion 110 and the pressure applicator 120 to securely fasten them together and prevent movement of the pressure applicator 120 relative to the base portion 110. In one alternative implementation, the connecting structure 130 is formed integrally with the base portion 110 and is connected to the pressure applicator 120. In another alternative implementation, the connecting structure 130 is formed integrally with the pressure applicator 120 and is connected to the base portion 110.

In one implementation, the connecting structure 130 is a post that is secured to the base portion 110 and the pressure applicator 120 by a friction fit or a snap fit. In another implementation, the connecting structure 130 is a post that is connected to the base portion 110 and the pressure applicator 120 by an adhesive. In another implementation, the connecting structure 130 is a post that is connected to the base portion 110 and the pressure applicator 120 by additional fasteners. In another implementation, the connecting structure 130 is a threaded fastener that secures the pressure applicator 120 to the base portion 110. Other structures can be used as the connecting structure 130 to fasten the pressure applicator 120 to the base portion 110.

The top surface 112 and the bottom surface 114 of the base portion 110 may be oriented transverse to the axis 101 and extend outward from the axis 101 to define the width dimension of the base portion 110. The pressure applicator 120 may extend upward from the top surface 112 of the base portion 110 along the axis 101. The pressure applicator 120 may be aligned on the axis 101 or may be offset from the axis 101. In one implementation, the base portion 110 is circular, the axis 101 extends perpendicular to the top surface 112 of the base portion 110 at a radial center of the base portion 110, and the pressure applicator 120 extends along the axis 101.

FIG. 5 is an illustration showing use of the therapy device 100 in applying pressure to a localized area of myofascial tissue from the exterior of the body of a patient 140 at a treatment site 142. The therapy device 100 is placed on a soft surface 150. The soft surface 150 is one that conforms to the body shape of the patient 140, such as a cushion, a couch or sofa, or a bed mattress. The therapy device 100 is placed on the soft surface 150 such that the bottom surface of the therapy device 100 is supported by the soft surface 150 and the pressure applicator 120 extends upward relative to the soft surface 150. The patient 140 is positioned on the soft surface 150 such that the therapy device 100 is located between the patient 140 and the soft surface 150, and the pressure applicator 120 is in engagement with the treatment site. Positioning the therapy device 100 on the soft surface 150 causes a broad deformation 152 in the soft surface 150, and engagement of the pressure applicator 120 with the treatment site 142 causes deformation of the pressure applicator 120.

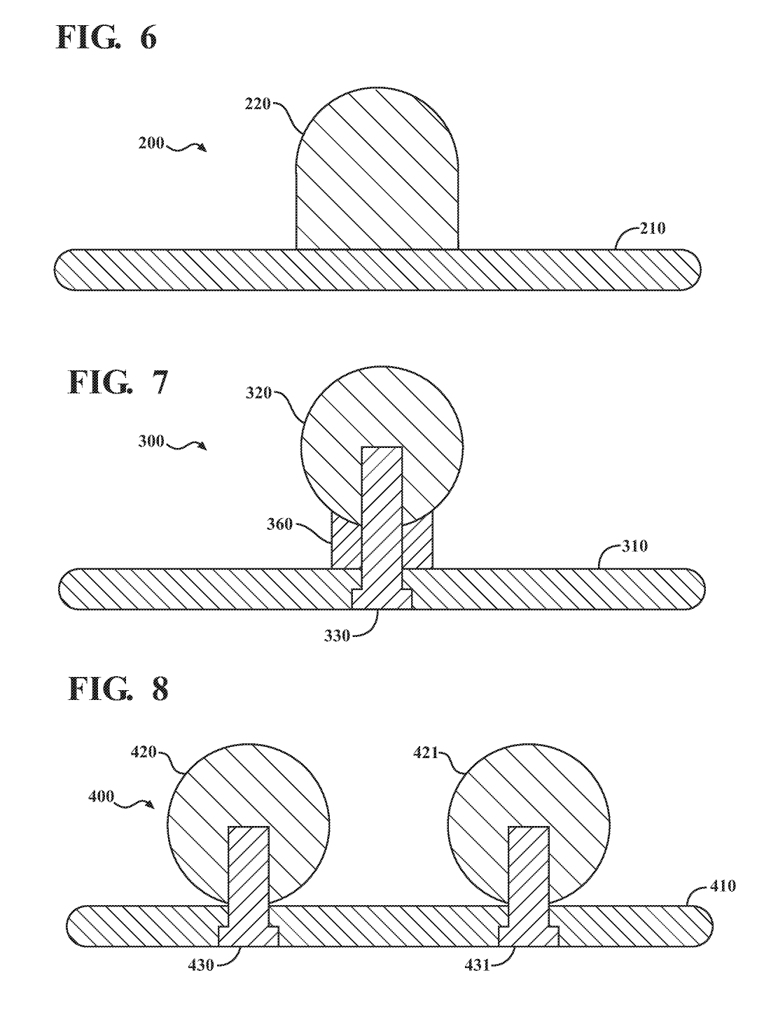

FIG. 6 is a side view showing a therapy device 200 according to a second example. The therapy device 200 is similar to the therapy device 100 except as described herein. The therapy device 200 includes a base portion 210 and a pressure applicator 220. The pressure applicator 220 has a cylindrical part that extends upward from the base portion 110 and a hemispherical part at the end of the cylindrical part. The hemispherical part of the pressure applicator 220 is engageable with the treatment site. The pressure applicator 220 may be formed integrally with the base portion 210 or may be formed separately and connected to the base portion 210 by fasteners or adhesives.

FIG. 7 is a side view showing a therapy device 300 according to a third example. The therapy device 300 is similar to the therapy device 100 except as described herein. The therapy device 300 includes a base portion 310 and a pressure applicator 320. In the illustrated example, the pressure applicator is spherical. The pressure applicator 320 is connected to the base portion 310 by a connecting structure 330. The pressure applicator 320 is spaced from the base portion 310 by a spacer element 360. As an example, the spacer element 360 may be a cylindrical structure, and the connecting structure 330 may extend through a bore that extends axially through the spacer element 360.

FIG. 8 is a side view showing a therapy device 400 according to a fourth example. The therapy device 400 is similar to the therapy device 100 except as described herein. The therapy device 400 includes a base portion 410, a first pressure applicator 420, and a second pressure applicator 421 that is offset from the first pressure applicator 420. The first pressure applicator 420 and the second pressure applicator 421 may be connected to the base portion 410 by a first connecting structure 430 and a second connecting structure 431, respectively.

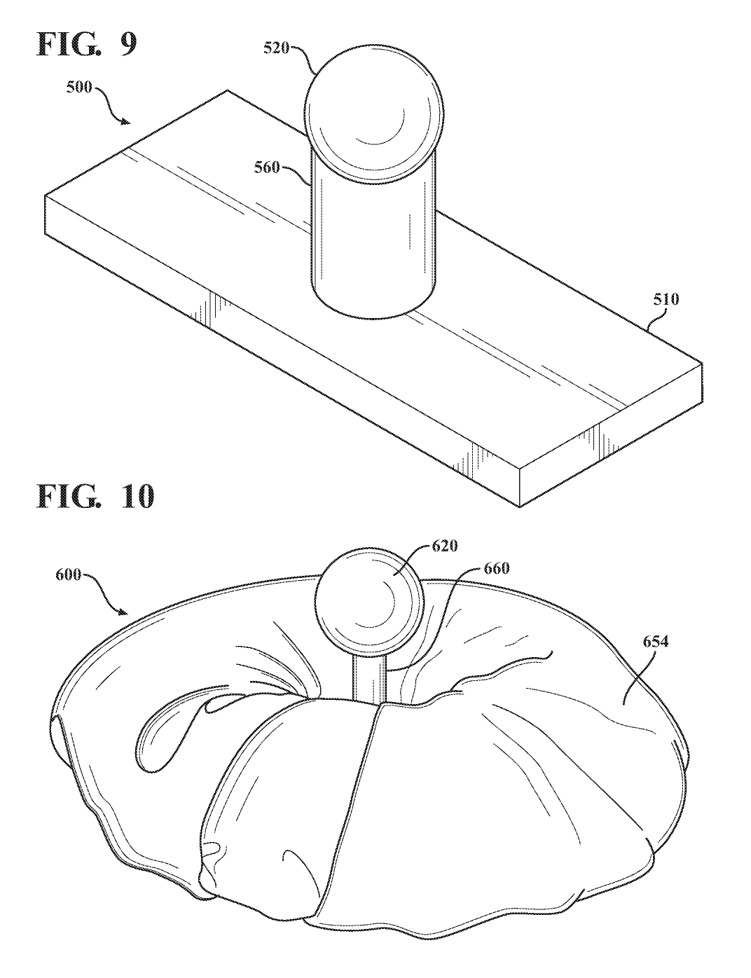

FIG. 9 is a perspective view showing a therapy device 500 according to a fifth example. The therapy device 500 is similar to the therapy device 100 except as described herein. The therapy device 500 includes a rectangular base portion 510. The rectangular base portion 510 may be, for example, three inches (7.62 cm) wide by twenty-four (60.96 cm) long. The therapy device 500 also includes a pressure applicator 520. In the illustrated example, the pressure applicator 520 is spherical. The pressure applicator 520 is connected to the rectangular base portion 510 by a connecting structure (not shown). The pressure applicator 520 is spaced from the rectangular base portion 510 by a spacer element 560. As an example, the spacer element 560 may be a cylindrical structure, and the connecting structure may extend through a bore that extends axially through the spacer element 560. The spacer element 560 may have a diameter that is equal to or slightly smaller than the diameter of the pressure applicator 520. For example, the spacer element 560 may have a diameter of one-and-one-eighth inches (2.875 cm) and the pressure applicator 520 may have a diameter of one-and-one-quarter inches (3.175 cm).

FIGS. 10-11 illustrate a therapy device 600 according to a sixth example. The therapy device 600 is similar to the therapy device 100 except as described herein. The therapy device 600 includes a supporting member 650 having a ring-like configuration disposed between an outer periphery of a base portion 610 and a pressure applicator 620. The supporting member 650 can be made from a cushioning type of material that does not deform significantly when pressure is applied, such as high density foam. When the patient 140 applies the pressure applicator 620 to a localized area of myofascial tissue, the supporting member 650 helps support the area of the patient's body that immediately surrounds the localized area of myofascial tissue by deforming slightly to conform to the area of the patient's body, which more evenly distributes pressure to the patient's body.

The geometrical configuration of an outer periphery 651 of the supporting member 650 can be substantially similar to the geometrical configuration of the outer periphery of the base portion 610. For example, the outer periphery 651 of the supporting member 650 and the outer periphery of the base portion 610 are curved in the illustrated example. An inner periphery 652 of the supporting member 650 can define an aperture from which the pressure applicator 620 and a connecting structure 660 extend. The thickness of the supporting member 650 can vary. For example, the thickness of the supporting member 650 could remain substantially the same between the outer periphery 651 and the inner periphery 652. In the illustrated example, the thickness of the supporting member 650 increases between the outer periphery 651 and the inner periphery 652 with an outer surface 653 having a substantially convex configuration. At its longest, the thickness of the supporting member 650 at the inner periphery 652 is less than the length of the connecting structure 660. In other implementations, the thickness of the supporting member 650 is substantially the same as or slightly less than the length of the connecting structure 660.

To protect the supporting member 650, a cover 654 can be provided that surrounds the supporting member 650. In the illustrated example, the cover 654 surrounds the supporting member 650 and the base portion 610. Ends of the cover 654 are fastened to the base portion 610 in the aperture defined by the inner periphery 652 of the supporting member 650 through the use of conventional fasteners, such as adhesive or staples. Although not limited to any specific material, the cover 654 may be formed from a flexible material, such as cloth. In the illustrated example, the cover 654 is formed out of leather. In other implementations, no cover is provided and the supporting member 650 directly contacts the patient's body.

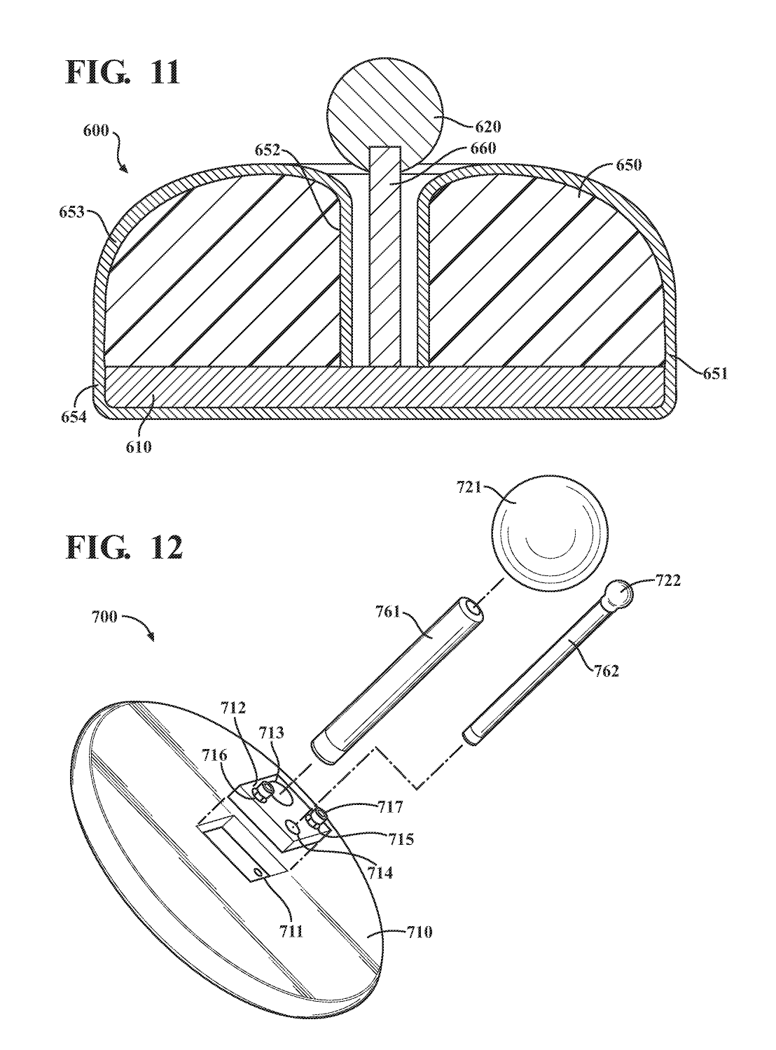

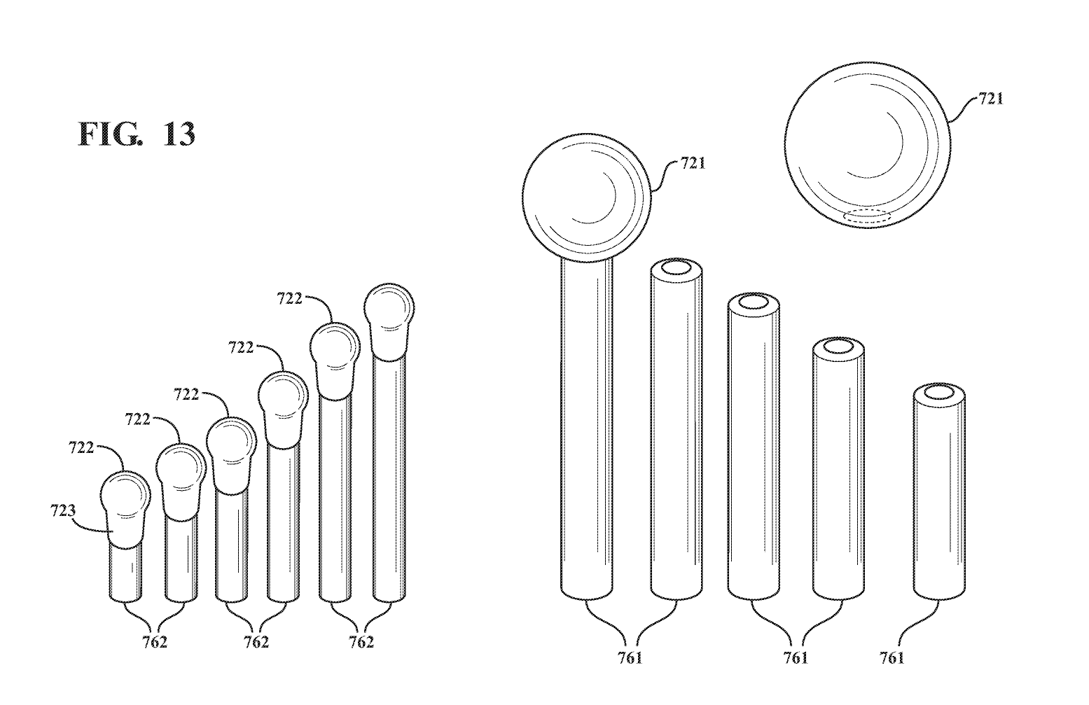

FIGS. 12-13 illustrate a therapy device 700 according to a seventh example. The therapy device 700 is similar to the therapy device 100 except as described herein. The therapy device 700 includes a base portion 710, a first set of pressure applicators 721, a second set of pressure applicators 722, a first set of connecting structures 761, and a second set of connecting structures 762. As will be explained, the first set of pressure applicators 721 are interchangeable with one another. The first set of connecting structures 761 are also interchangeable with one another, as are the second set of connecting structures 762.

In the illustrated example, the base portion 710 includes a recess 711 that is substantially centered. The recess 711 could be provided elsewhere in the base portion 710 or omitted entirely. An adapter 712 can be seated in the recess 711. The adapter 712 can be fabricated from any suitable material, such as metal. In the illustrated example, the adapter 712 and the recess 711 each have a substantially rectangular configuration. The adapter 712 can have a first aperture 713, a second aperture 714, a third aperture 715, and a fourth aperture 716. The third aperture 715 and the fourth aperture 716 can be configured to receive conventional fasteners 717, which can be used to secure the adapter 712 to the base portion 710. The first aperture 713 and the second aperture 714 can be configured to matingly receive and temporarily secure one of the connecting structures 761, 762 from either the first set of connecting structures 761 or the second set of connecting structures 762, respectively. In the illustrated example, the first aperture 713 and the second aperture 714 are threaded and have different sized diameters.

So that one connecting structure 761 from the first set of connecting structures 761 can be received within the first aperture 713, each of the connecting structures 761 have substantially the same diameter, which is slightly smaller than the diameter of the first aperture 713. In the illustrated example, a first end of each connecting structure 761 from the first set of connecting structures 761 is provided with threading that is complementary to the threading of the first aperture 713. A second end of each connecting structure 761 from the first set of connecting structures 761 is configured for attachment to one pressure applicator 721 from the first set of pressure applicators 721 in a manner previously described.

Similarly, each connecting structure 762 from the second set of connecting structures 762 has substantially the same diameter, which is slightly smaller than the diameter of the second aperture 714 so that one connecting structure 762 can be received within the second aperture 714. In the illustrated example, a first end of each connecting structure 762 from the second set of connecting structures 762 is provided with threading that is complementary to the threading of the second aperture 714. A second end of each connecting structure 762 from the second set of connecting structures 762 is configured for attached to one pressure applicator 722 from the second set of pressure applicators 722. In the illustrated example, each pressure applicator 722 from the second set of pressure applicators 722 includes an extension 723 having a substantially tubular configuration that the second end of the pressure applicator 722 is secured within via a friction fit. The extension 723 can be connected to or integrally formed with the pressure applicator 722. In some implementations, each connecting structure 762 from the second set of connecting structures 762 has its own pressure applicator 722, and each pressure applicator 722 from the second set of pressure applicators 722 can have substantially the same diameter.

To allow the patient to customize the therapy device 700, each connecting structure 761, 762 from the first set of connecting structures 761 and the second set of connecting structures 762 can have a different length. In some implementations, the lengths of the connecting structures 761, 762 are between one inch (2.54 cm) and twelve inches (30.48 cm). Similarly, each pressure applicator 721, 722 from the first set of pressure applicators 721 and the second set of pressure applicators 722 can have a different Shore C hardness value and/or a different sized diameter. This allows the patient to select a desired pressure applicator 721, 722 in combination with a desired length of the connecting structure 761, 762. By providing the first aperture 713 and the second aperture 714 in the base portion 710, the patient can also select whether to use one of the pressure applicators 721, 722 and one of the connecting structures 761, 622 or two of the pressure applicators 721, 722 and two of the connecting structures 761, 762 at once. When two of the connecting structures 761, 762 are used with the therapy device 700, the connecting structures 761, 762 are substantially parallel to one another and substantially transverse to the base portion 710. In some implementations, the therapy device 700 can incorporate the supporting member 650 of the therapy device 600.

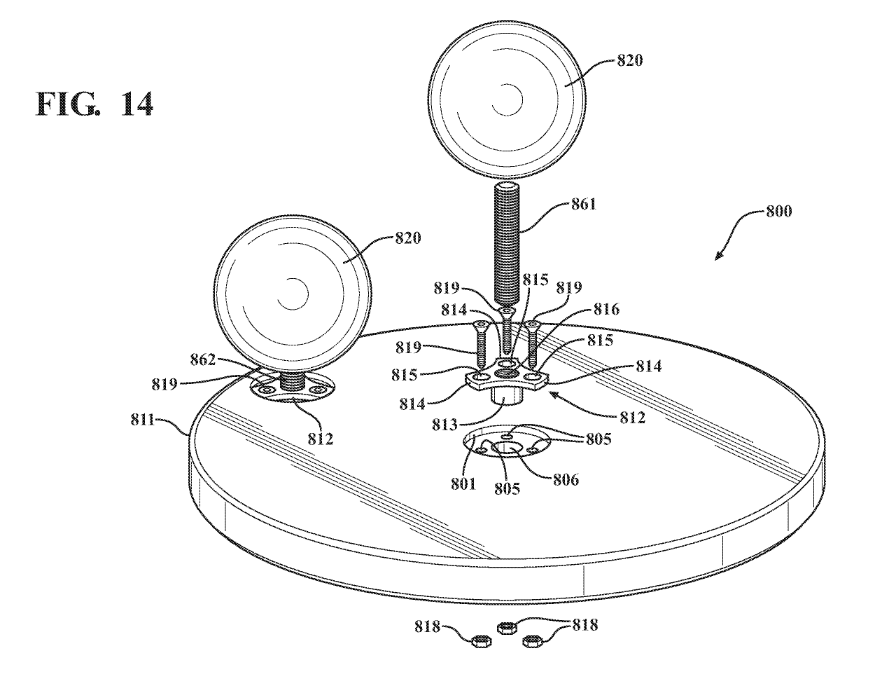

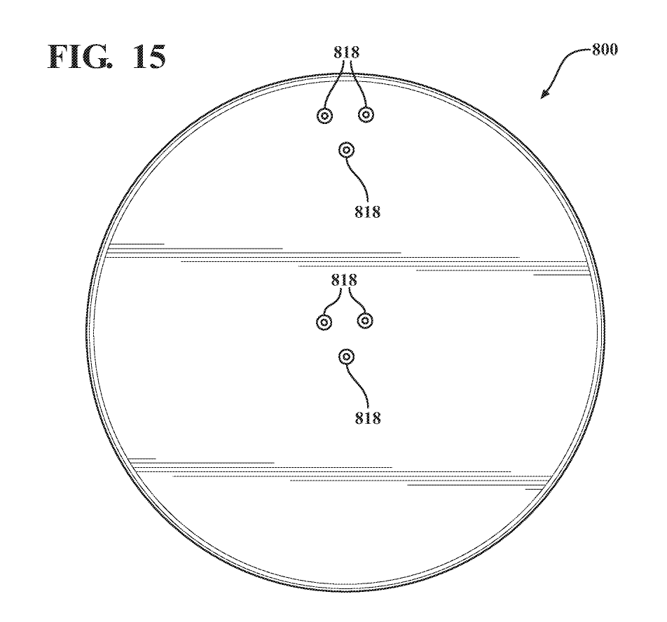

FIGS. 14-15 illustrate a therapy device 800 according to an eighth example. The therapy device 800 is similar to the therapy device 100 except as described herein. The therapy device 800 provides a first connecting structure 861 and a second connecting structure 862 that each provide a pressure applicator 820 on one end. As shown, the pressure applicators 820 are substantially similar. However, the pressure applicators 820 can be different. For example, one pressure applicator 820 could have a larger diameter or be made from a different material.

In the illustrated example, the first and second connecting structures 861, 862 have different lengths and are threaded. The threading allows the ends of the first and second connecting structures 861, 862 to be matingly received and secured within a threaded bore (not shown) in the pressure applicators 820 and a threaded bore 816 in an adapter 812 secured to a base portion 810. As shown, the first connecting structure 861 is longer than the second connecting structure 862 and is connected to the center of the base portion 810, and the second connecting structure 862 is connected near a periphery 811 of the base portion 810.

As previously explained, the adapters 812 can be used to attach the first and second connecting structures 861, 862 to the base portion 810. Alternatively, the first and second connecting structures 861, 862 can be connected directly to the base portion 810 without use of the adapters 812. In the illustrated example, each adapter 812 has a tubular body 813 with three flanges 814 that are substantially coplanar extending substantially perpendicular and spaced in an equidistant manner from an end of the tubular body 813. Although there are three flanges 814 in the illustrated example, the adapters 812 can include any number of the flanges 814. Each flange 814 has a bore 815 extending therethrough that is substantially parallel to the threaded bore 816 extending through the tubular body 813. To secure the adapter 812 to the base portion 810, the bores 815 in the flanges 814 can be sized to receive a fastener 819, such as a screw.

The base portion 810 can be provided with recesses 801 that matingly receive the adapters 812. In the illustrated example, there are two recesses 801 in the base portion 810, and an outer surface of the adapters 812 is substantially flush with an outer surface of the base portion 810 when the adapters 812 are received within their respective recess 801. Each recess 801 can be provided with a center bore 806 that extends axially through a center of the recess 801 and a plurality of outer bores 805 that surround the center bore 806. The center bore 806 and the outer bores 805 are sized, spaced, and aligned so that the center bore 806 is capable of receiving the tubular body 813 of the adapter 812 and each of the outer bores 805 is capable of receiving a fastener 819 secured through a bore 815 in a flange 814 of the adapter 812. In the illustrated example, the center bore 806 does not extend entirely through the base portion 810, and the outer bores 805 extend through the base portion 810 so that a nut 818 can be used with the fastener 819 to secure the adapter 812 to the base portion 810.

The therapy devices that are described herein, including the therapy device 100, the therapy device 200, the therapy device 300, the therapy device 400, the therapy device 500, the therapy device 600, the therapy device 700, and the therapy device 800 can be utilized to treat specific disorders that are related to myofascial trigger points.

As one example, the therapy devices described herein, such as the therapy device 100, can be utilized to treat restless leg syndrome. The treatment process includes diagnosing a patient as suffering from restless leg syndrome based on symptoms exhibited by the patient. In response to the diagnosis, the treatment process includes identifying trigger points that are associated with leg muscle dysfunction, such as gluteal trigger points. The treatment process also includes prescribing a course of treatment in which trigger point release is performed with respect to the identified trigger points repeatedly, according to a treatment frequency (e.g. once per day).

Trigger point release is performed according to the prescribed course of treatment using the therapy device 100 or another of the therapy devices described herein as previously described, such as by placing the therapy device 100 on a soft surface and positioning the patient's body on the soft surface such that a treatment site including one of the indicated trigger points is placed in engagement with the pressure applicator 120 of the therapy device 100.

While this disclosure has been made in connection with specific implementations, it is to be understood that various modifications or equivalent arrangements are included within the scope of the appended claims.

What is claimed is:

1. A trigger point therapy device for applying pressure to a localized area of myofascial tissue that is accessed from an exterior of a patient's body, comprising:
a base portion that has a top surface and a bottom surface that are oriented transverse to an axis, wherein the base portion extends outward from the axis to define a width dimension for the base portion; and
a pressure applicator that is connected to the base portion and extends upward from the top surface of the base portion along the axis.

2. The trigger point therapy device of claim 1, wherein the width dimension of the base portion is at least twice a width dimension of the pressure applicator.

3. The trigger point therapy device of claim 2, wherein a height dimension of the pressure applicator is equal to or greater than the width dimension of the pressure applicator.

4. The trigger point therapy device of claim 1, wherein at least part of the pressure applicator is hemispherical.

5. The trigger point therapy device of claim 1, wherein at least part of the pressure application is spherical.

6. The trigger point therapy device of claim 1, wherein at least part of the pressure applicator is formed from a flexible material.

7. The trigger point therapy device of claim 1, wherein the base portion is formed from a rigid material and has a circular periphery.

8. The trigger point therapy device of claim 7, wherein the pressure applicator is positioned in a radial center of the circular periphery of the base portion.

9. The trigger point therapy device of claim 1, wherein at least one of the top surface of the base portion or the bottom surface of the base portion is planar.

10. The trigger point therapy device of claim 1, further comprising:
a connecting structure that extends upward from the top surface of the base portion along the axis and connects the pressure applicator to the base portion.

11. The trigger point therapy device of claim 10, wherein the pressure applicator is removably attached to the connecting structure.

12. The trigger point therapy device of claim 1, further comprising,
a second pressure applicator that is connected to the base portion and extends upward from the top surface of the base portion along a second axis that is parallel to the axis.

13. The trigger point therapy device of claim 12, further comprising:
a first set of connecting structures removably connectable to the pressure applicator and the base portion; and
a second set of connecting structures removably connectable to the second pressure applicator and the base portion,
wherein one of the connecting structures from the first set of connecting structures is connected to the pressure applicator and the base portion at a time and can be replaced by another connecting structure from the first set of connecting structures at a user's discretion, and
wherein one of the connecting structures from the second set of connecting structures is connected to the pressure applicator and the base portion at a time and can be replaced by another connecting structure from the second set of connecting structures at the user's discretion.

14. The trigger point therapy device of claim 13, wherein lengths of the connecting structures from the first set of connecting structures vary, and lengths of the connecting structures from the second set of connecting structures vary.

15. The trigger point therapy device of claim 13, wherein the pressure applicator has a first diameter, the second pressure applicator has a second diameter, and the first diameter is different than the second diameter.

16. The trigger point therapy device of claim 12, further comprising:
a first connecting structure that extends upward from the top surface of the base portion along the axis and connects the pressure applicator to the base portion; and
a second connecting structure that extends upward from the top surface of the base portion along the second axis and connects the second pressure applicator to the base portion,
wherein a length of the first connecting structure is longer than a length of the second connecting structure.

17. The trigger point therapy device of claim 1, further comprising:
a supporting member having a ring-like configuration, wherein the supporting member is connected to the base portion and surrounds the pressure applicator.

18. The trigger point therapy device of claim 17, further comprising:
a connecting structure that extends upward from the top surface of the base portion along the axis and connects the pressure applicator to the base portion, wherein the supporting member surrounds the connecting structure and the pressure applicator, and wherein at least a portion of the pressure applicator extends beyond the supporting member.

19. The trigger point therapy device of claim 17, wherein a thickness of the supporting member decreases from an inner periphery to an outer periphery.

20. A method for applying pressure to a localized area of myofascial tissue from an exterior of a patient's body, comprising:
placing a device on a soft surface, the device including a base portion that has a top surface and a bottom surface that are oriented transverse to an axis and extend outward from the axis to define a width dimension for the base portion, and a pressure applicator that is connected to the base portion and extends upward from the top surface along the axis, wherein the device is placed on the soft surface such that the bottom surface of the device is supported by the soft surface and the pressure applicator extends upward relative to the soft surface; and
positioning a patient on the soft surface such that the device is located between the patient and the soft surface and the pressure applicator is in engagement with the localized area of myofascial tissue.
